(19) United States
(12) Patent Application Publication
(10) Pub. No.: US 2011/0214445 A1
(43) Pub. Date: Sep. 8, 2011

(54) Pipe connection unit and air conditioner having the same

(75) Inventors: Jae Oh Han, Yongin-si (KR); Seong Ho Kil, Seongnam-si (KR); Ji Ho Kwak, Suwon-si (KR)

(73) Assignee: SAMSUNG ELECTRONICS CO., LTD., Suwon-si (KR)

(21) Appl. No.: 12/929,922

(22) Filed: Feb. 24, 2011

(30) Foreign Application Priority Data
Mar. 3, 2010 (KR) 10-2010-0019103

(51) Int. Cl. F25D 23/00; F16L 19/06

(52) U.S. Cl. 62/259.1; 285/343

(57) ABSTRACT

A pipe connection unit to connect a first pipe made of a first material and a second pipe made of a second material, and an air conditioner having the same. The pipe connection unit includes a first connection member fixed to the first pipe, a second connection member coupled with the first connection member, and a ferrule received in the second connection member so as to be closely fixed to the outer circumferential surface of the second pipe according to the coupling of the first connection member and the second connection member with each other, thereby simply connecting the first pipe and the second pipe through the coupling of the first connection member and the second connection member with each other.

### CROSS-REFERENCE TO RELATED APPLICATIONS

This application claims the benefit of Korean Patent Application No. 2010-0019103, filed on Mar. 3, 2010 in the Korean Intellectual Property Office, the disclosure of which is incorporated herein by reference.

### BACKGROUND

1. Field

Embodiments relate to a pipe connection unit to connect two pipes, and an air conditioner in which refrigerant pipes of an indoor unit and an outdoor unit are connected by the pipe connection unit.

2. Description of the Related Art

In general, an air conditioner is an apparatus which cools or heats an indoor space through a refrigerating cycle. Among air conditioners, there is a split type air conditioner including an indoor unit installed indoors and an outer unit installed outdoors.

The indoor unit includes an indoor heat exchanger to perform heat exchange with indoor air and an indoor air blower fan, and the outdoor unit includes an outdoor heat exchanger to perform heat exchange with outdoor air, an outdoor air blower fan, a compressor to compress a refrigerant, and an expansion valve to expand the refrigerant. The indoor heat exchanger, the outdoor heat exchanger, the compressor, and the expansion valves are connected by pipes such that the refrigerant may be circulated through the indoor heat exchanger, the outdoor heat exchanger, the compressor, and the expansion valves.

Therefore, installation of such a split type air conditioner is completed by respectively installing the indoor unit and the outdoor unit in an indoor space and an outdoor space and then by connecting one end of a connection pipe to a refrigerant pipe extended from the indoor unit and connecting the other end of the connection pipe to a refrigerant pipe extended from the outdoor unit so as to allow the refrigerant to be circulated through the indoor unit and the outdoor unit.

### SUMMARY

Therefore, it is an aspect to provide a pipe connection unit which more conveniently connects refrigerant pipes, and an air conditioner having the same.

Additional aspects will be set forth in part in the description which follows and, in part, will be apparent from the description, or may be learned by practice of the invention.

In accordance with one aspect, a pipe connection unit to connect a first pipe made of a first material and a second pipe made of a second material includes a first connection member provided with a first installation hole, in which one end of the first pipe is installed, and a second installation hole, in which one end of the second pipe is installed, a second connection member provided with a first through hole, through which the second pipe passes, and coupled with the first connection member, a ferrule made of the second material, provided with a second through hole, through which the second pipe passes, and received in the second connection member so as to be closely fixed to the outer circumferential surface of the second pipe according to the coupling of the first connection member and the second connection member with each other, and an insulation member made of an insulating material and interposed between the second connection member and the second pipe.

A first coupling part with a male screw formed thereon may be provided on the first connection member, and a second coupling part with a female screw formed thereon and coupled with the first coupling part may be provided on the second connection member.

The second connection member may include a ferrule receiving part having a larger diameter than that of the first through hole and formed at the inside of the second coupling part to receive the ferrule.

An insulation member installation part having a larger diameter than that of the first through hole to install the insulation member thereon may be provided at one end of the first through hole of the second connection member.

The first connection member may include a guide part having an inner diameter gradually increasing towards the end of the first connection member corresponding to the ferrule, and the ferrule may include a wedge part having an outer diameter gradually decreasing towards the end of the ferrule corresponding to the guide part.

The pipe connection unit may further include a sealing member, to which the end of the second pipe is closely adhered, formed in a ring shape, and the end of the second pipe may pass through the first through hole and the second through hole and enter the second installation hole.

In accordance with another aspect, an air conditioner includes an indoor unit and an outdoor unit, refrigerant pipes made of a first material and extended from any one of the indoor unit and the outdoor unit, connection pipes made of a second material and respectively connected with the refrigerant pipes, and pipe connection units to respectively connect the refrigerant pipes and the connection pipes, wherein each pipe connection unit includes a first connection member provided with a first installation hole, in which one end of the first pipe is installed, and a second installation hole, in which one end of the second pipe is installed, and connected to each refrigerant pipe by welding, a second connection member provided with a first through hole, through which each connection pipe passes, and coupled with the first connection member, a ferrule made of the second material, provided with a second through hole, through which each connection pipe passes, and received in the second connection member so as to be closely fixed to the outer circumferential surface of each connection pipe according to the coupling of the first connection member and the second connection member with each other, and an insulation member made of an insulating material and interposed between the second connection member and each connection pipe.

The first material may include any one of copper and aluminum, and the second material may include the other one of copper and aluminum.

A material of the first connection member and the second connection member may include brass.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic view illustrating a configuration of an air conditioner in accordance with one embodiment;

FIG. 2 is an exploded perspective view of a pipe connection unit applied to the air conditioner in accordance with the embodiment; and

FIGS. 3 and 4 are sectional views illustrating a connection process of two pipes by the pipe connection unit applied to the air conditioner in accordance with the embodiment.

### DETAILED DESCRIPTION

Reference will now be made in detail to the embodiments, examples of which are illustrated in the accompanying drawings, wherein like reference numerals refer to like elements throughout.

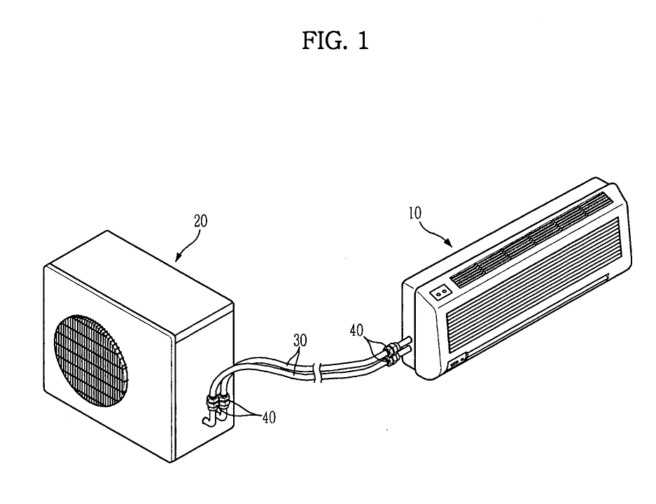

As shown in FIG. 1, an air conditioner in accordance with one embodiment includes an indoor unit 10 installed in an indoor space, and an outdoor unit 20 installed in an outdoor space. The indoor unit 10 and the outdoor unit 20 are respectively provided with refrigerant pipes 11 and 21 extended from heat exchangers (not shown) respectively installed in the indoor unit 10 and the outdoor unit 20, and the two refrigerant pipes 11 and 21 extended from the indoor unit 10 and the outdoor unit 20 are connected to each other through connection pipes 30. That is, one end of the connection pipe 30 is connected to the refrigerant pipe 11 provided on the indoor unit 10, and the other end of the connection pipe 30 is connected to the refrigerant pipe 21 provided on the outdoor unit 20, thereby allowing a refrigerant to be circulated through the indoor unit 10 and the outdoor unit 20.

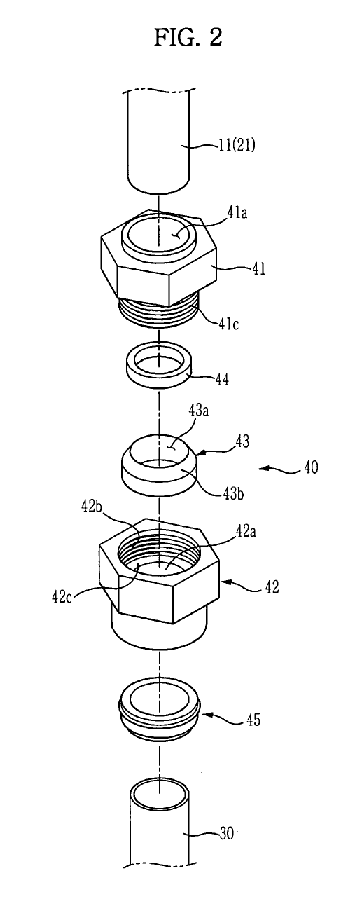

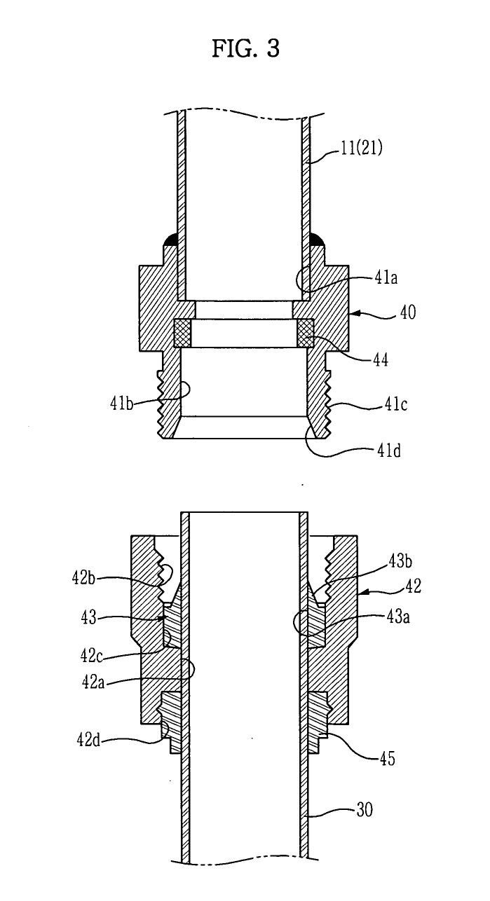

The refrigerant pipes 11 and 21 and the connection pipes 30 are connected to each other through pipe connection units 40. As shown in FIGS. 2 and 3, the pipe connection unit 40 serves to connect a first pipe made of a first material and a second pipe made of a second material to each other. In this embodiment, the first pipe made of the first material is the refrigerant pipe 11 or 21 made of copper, and the second pipe made of the second material is the connection pipe 30 made of aluminum.

The pipe connection unit 40 includes a first connection member 41 provided with a first installation hole 41a, in which one end of the refrigerant pipe 11 or 21 is installed, and a second installation hole 41b, in which one end of the connection pipe 30 is installed, at both sides thereof, a second connection member 42 provided with a first through hole 42a, through which the connection pipe 30 passes, and coupled with the first connection member 41, and a ferrule 43 provided with a second through hole 43a, through which the connection pipe 30 passes, received in the second connection member 42 so as to be closely fixed to the outer circumferential surface of the connection pipe 30 installed in the second through hole 43a according to the coupling of the first connection member 41 and the second connection member 42 with each other. In this embodiment, the first connection member 41 and the second connection member 42 are made of brass having high corrosion resistance. Further, in order to reduce galvanic corrosion generated when different kinds of metal contact each other, the ferrule 43 is made of the same material as that of the second pipe, i.e. aluminum in the same manner as the connection pipe 30 in this embodiment.

In order to couple the first connection member 41 and the second connection member 42 with each other, a first coupling part 41c with a male screw formed on the outer circumferential surface thereof is provided on one end of the first connection member 41 facing the second connection member 42, and a second coupling part 42b with a female screw formed on the inner circumferential surface thereof and coupled with the first coupling part 41c is provided on one end of the second connection member 42 facing the first connection member 41. In this embodiment, the external surface of the first installation hole 41a of the first connection member 41 and the external surface of the second coupling part 42b of the second connection member 42 are formed in a hexagonal shape so as to enable a worker to easily apply external force thereto.

A ferrule receiving part 42c having a larger diameter than that of the first through hole 42a to receive the ferrule 43 is provided at the inside of the second coupling part 42b of the second connection member 42.

In order to adhere the ferrule 43 closely to the outer circumferential surface of the connection pipe 30 according to the coupling of the first connection member 41 and the second connection member 42 with each other, a guide part 41d having an inner diameter gradually increasing towards the end of the first connection member 41 corresponding to the ferrule 43 is provided on the first connection member 41, and a wedge part 43b having an outer diameter gradually decreasing towards the end of the ferrule 43 corresponding to the guide part 41d is provided on the ferrule 43. In this embodiment, the guide part 41d is formed at the inside of the first connection part 41c.

A ring-shaped sealing member 44, to which one end of the connection pipe 30 installed in the second installation hole 41b is closely adhered, so as to maintain a hermetically sealed state, is installed within the second installation hole 41b of the first connection member 41.

If a connection portion between the second connection member 42 made of brass and the connection pipe 30 made of aluminum is exposed to air, galvanic corrosion may be more seriously generated through such a connection portion. Therefore, an insulation member 45 to prevent the connection portion between the second connection member 42 and the connection pipe 30 from be exposed to air is installed on the second connection member 42. The insulation member 45 is made of a polymer, such as Teflon, and is formed in a ring shape having an inner diameter corresponding to the outer diameter of the connection pipe 30.

An insulation member installation part 42d on which the insulation member 45 is installed is provided on the second connection member 42. In this embodiment, the insulation member installation part 42d having a larger diameter than that of the first through hole 42a is provided at one end of the second connection member 42 opposite to the end of the second connection member 42 facing the first connection member 41, thereby allowing the insulation member 45 to be interposed between the end of the second connection member 42 and the connection pipe 30.

Hereinafter, a connection process of the refrigerant pipe 11 or 21 and the connection pipe 30 through the above pipe connection unit 40 will be described with reference to the accompanying drawings.

As shown in FIG. 3, the first connection member 41 is fixed to the refrigerant pipe 11 or 21 by welding under the condition that one end of the refrigerant pipe 11 or 21 is installed in the first installation hole 41a of the first connection member 41. The ferrule 43 is received in the ferrule receiving part 42c of the second connection member 42, and then one end of the connection pipe 30 passes through the first through hole 42a and the second through hole 43a and is installed in the second installation hole 41b.

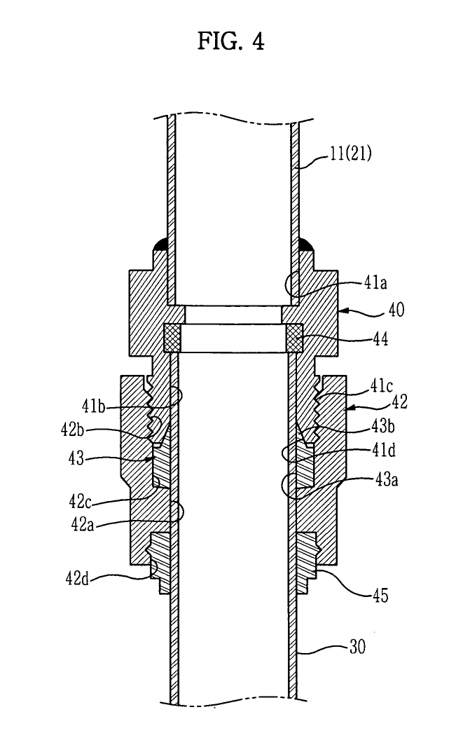

Under the above condition, when the first connection member 41 and the second connection member 42 are coupled with each other through the first coupling part 41c and the second coupling part 42b by rotating the second connection member 42, the ferrule 43 proceeds to the inside of the guide part 41d, as shown in FIG. 4, and the wedge part 43b of the ferrule 43 is deformed inwardly in the radial direction thereof by the guide part 41d, partially penetrates into the outer circumferential surface of the connection pipe 30, and is closely fixed to the outer circumferential surface of the connection pipe 30.

Under the condition that the ferrule 43 is closely fixed to the outer circumferential surface of the connection pipe 30, when the coupling of the first connection member 41 and the second connection member 42 is continuously performed by continuously rotating the second connection member 42, the connection pipe 30 fixed to the ferrule 43 moves toward the first connection member 41 together with the ferrule 43. Thereby, one end of the connection pipe 30 is adhered closely to the sealing member 44 installed in the second installation hole 41b while elastically deforming the sealing member 44, and thus a hermetically sealed state between the sealing member 44 and the end of the connection pipe 30 is maintained. That is, connection of the refrigerant pipe 11 or 21 and the connection pipe 30 is simply carried out by coupling the second coupling part 42b of the second connection member 42 with the first coupling part 41c of the first connection member 41.

Although in this embodiment, the pipe connection unit 40 is used to connect the refrigerant pipe 11 or 21 and the connection pipe 30 of the air conditioner, the pipe connection unit 40 may be used to connect a first pipe and a second pipe made of different materials in various fields.

As is apparent from the above description, a pipe connection unit and an air conditioner having the same in accordance with one embodiment of the present invention simply connect two pipes, i.e. a refrigerant pipe and a connection pipe, by coupling a first connection member and a second connection member with each other.

Further, the pipe connection unit and the air conditioner having the same in accordance with the embodiment of the present invention reduce galvanic corrosion generated if two pipes made of different materials are connected.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A pipe connection unit to connect a first pipe made of a first material and a second pipe made of a second material different from the first material, the pipe connection unit comprising:
a first connection member provided with a first installation hole, in which one end of the first pipe is installed, and a second installation hole, in which one end of the second pipe is installed;
a second connection member provided with a first through hole, through which the second pipe passes, and coupled with the first connection member;
a ferrule made of the second material, provided with a second through hole, through which the second pipe passes, and received in the second connection member so as to be closely fixed to the outer circumferential surface of the second pipe according to the coupling of the first connection member and the second connection member with each other; and
an insulation member made of an insulating material and interposed between the second connection member and the second pipe.

2. The pipe connection unit according to claim 1, wherein a first coupling part with a male screw formed thereon is provided on the first connection member, and a second coupling part with a female screw formed thereon and coupled with the first coupling part is provided on the second connection member.

3. The pipe connection unit according to claim 2, wherein the second connection member includes a ferrule receiving part having a larger diameter than that of the first through hole and formed at the inside of the second coupling part to receive the ferrule.

4. The pipe connection unit according to claim 1, wherein an insulation member installation part having a larger diameter than that of the first through hole to install the insulation member thereon is provided at one end of the first through hole of the second connection member.

5. The pipe connection unit according to claim 1, wherein the first connection member includes a guide part having an inner diameter gradually increasing towards the end of the first connection member corresponding to the ferrule, and the ferrule includes a wedge part having an outer diameter gradually decreasing towards the end of the ferrule corresponding to the guide part.

6. The pipe connection unit according to claim 1, further comprising a sealing member, to which the end of the second pipe is closely adhered, formed in a ring shape,
wherein the end of the second pipe passes through the first through hole and the second through hole and enters the second installation hole.

7. An air conditioner comprising:
an indoor unit and an outdoor unit;
refrigerant pipes made of a first material and extended from any one of the indoor unit and the outdoor unit;
connection pipes made of a second material and respectively connected with the refrigerant pipes, the second material being different from the first material; and
pipe connection units to respectively connect the refrigerant pipes and the connection pipes,
wherein each pipe connection unit includes:
a first connection member provided with a first installation hole, in which one end of the first pipe is installed, and a second installation hole, in which one end of the second pipe is installed, and connected to each refrigerant pipe by welding;
a second connection member provided with a first through hole, through which each connection pipe passes, and coupled with the first connection member;
a ferrule made of the second material, provided with a second through hole, through which each connection pipe passes, and received in the second connection member so as to be closely fixed to the outer circumferential surface of each connection pipe according to the coupling of the first connection member and the second connection member with each other; and
an insulation member made of an insulating material and interposed between the second connection member and each connection pipe.

8. The air conditioner according to claim 7, wherein a first coupling part with a male screw formed thereon is provided on the first connection member, and a second coupling part with a female screw formed thereon and coupled with the first coupling part is provided on the second connection member.

9. The air conditioner according to claim 8, wherein the second connection member includes a ferrule receiving part having a larger diameter than that of the first through hole and formed at the inside of the second coupling part to receive the ferrule.

10. The air conditioner according to claim 7, wherein an insulation member installation part having a larger diameter than that of the first through hole to install the insulation member thereon is provided at one end of the first through hole of the second connection member.

11. The air conditioner according to claim 7, wherein the first connection member includes a guide part having an inner diameter gradually increasing towards the end of the first connection member corresponding to the ferrule, and the ferrule includes a wedge part having an outer diameter gradually decreasing towards the end of the ferrule corresponding to the guide part.

12. The air conditioner according to claim 7, further comprising a sealing member, to which the end of each connection pipe is closely adhered, formed in a ring shape,
wherein the end of each connection pipe passes through the first through hole and the second through hole and enters the second installation hole, and

13. The air conditioner according to claim 7, wherein the first material includes any one of copper and aluminum, and the second material includes the other one of copper and aluminum.

14. The air conditioner according to claim 13, wherein a material of the first connection member and the second connection member includes brass.
